(19) United States
(12) Patent Application Publication
(10) Pub. No.: US 2004/0221631 A1
(43) Pub. Date: Nov. 11, 2004

(54) Composition for fertilizer tablet

(76) Inventor: Kurt J. Kerrigan, Pompano Beach, FL (US)

Correspondence Address: Robert M. Downey, ROBERT M. DOWNEY, P.A., Suite 350, 150 E. Palmetto Park Road, Boca Raton, FL, 33432, US

(21) Appl. No.: 10/235,610

(22) Filed: Sep. 5, 2002

(51) Int. Cl. C05D 1/00

(52) U.S. Cl. 71/31

(57) ABSTRACT

A fertilizer composition is provided in the form of a water soluble tablet which is structured to disintegrate and release into a stream of water at a predetermined rate, the composition including: N—P—K components in amounts ranging between 27% to 30% by weight of a nitrogen containing component, 27% to 30% by weight of a potassium containing component, and 19% to 22% by weight of a phosphorus containing component; a binder in an amount of between 2% and 4% by weight; a disintegrant in an amount of between 10% to 13% by weight; a lubricant in an amount of between 2% to 4% by weight; and a surfactant in an amount of between 0.01% to 1.0% by weight.

### BACKGROUND OF THE INVENTION

1. Field of the Invention

The present invention relates to fertilizer compositions and, more particularly, to a dry, water dispersible tablet containing nitrogen, potassium and phosphorus components. The tablet is structured to disintegrate when subjected to a stream of water so that the composition is released into the water stream at a predetermined rate and concentration.

2. Discussion of the Related Art

It is well known that lawns, plants, botanicals and other plant life require watering and fertilizing on a regular basis in order to maintain health and to promote growth. Small fertilizer pellets or granules for slow release in the soil, near the base of the plant, are well known and widely used in the related field. In some instances, spray devices may be used on a garden hose to simultaneously water and fertilize plants and flowers, using a liquid fertilizer product. During this application method, which is normally performed manually, the applied solution is quickly dispersed at uneven levels of distribution. Subsequent fertilization treatment is often neglected, as this application process is time consuming and expensive.

### SUMMARY OF THE INVENTION

The present invention is directed to a fertilizer composition, provided in the form of a water-soluble tablet, which is structured for slow release into a stream of flowing water in accordance with a predetermined rate of disintegration and concentration level. The formed tablet, containing the fertilizer composition, is particularly suited for use in a delivery system such as the SPRINKLELIZER System, shown and described at www.sprinklelizer.com and incorporated herein by reference.

The fertilizer composition includes N—P—K components, provided according to a ratio which has been found to be most effective when used in the chemical delivery system identified above. Specifically, a preferred embodiment of the composition includes Ammonium Sulfate in an amount of between 27% and 37% by weight of the composition, Potash in an amount of between 27% and 30% by weight of the composition and Triple Super Phosphate in an amount of between 19% and 22% by weight of the composition. Ammonium Phosphate may be substituted for Ammonium Sulfate and Potash to provide the desired N—P level. In a preferred embodiment, the binder agent is Polyvinyl Pyrillidone K30 and is present in an amount of between 2% and 4% by weight of the composition. A lubricant, surfactant and flow aid may further be incorporated in the composition to promote even and consistent distribution in the stream of water flow.

### OBJECTS AND ADVANTAGES OF THE INVENTION

It is a primary object of the present invention to provide a fertilizer composition for application to various plant life including lawns, plants, and botanicals on a systematic, regular basis.

It is a further object of the present invention to provide a fertilizer composition which is structured for slow release of fertilizer, in accordance with a predetermined concentration and rate of release, into a stream of water during normal plant watering.

It is still a further object of the present invention to provide a fertilizer composition providing a predetermined N—P—K ratio for simultaneous watering and feeding of plants on a regular basis.

It is yet a further object of the present invention to provide a fertilizer composition which is manufactured in the form of a dry, soluble tablet and which is structured to disintegrate when subjected to a flow of water in an irrigation system, thereby providing for automated, systematic watering and feeding of plant life on a scheduled cycle.

It is still a further object of the present invention to provide a fertilizer composition in a dry, water soluble tablet and wherein the composition includes a binder component for controlling a rate of disintegration of the tablet and release of the fertilizer into a stream of flowing water.

These and other objects and advantages of the present invention will be more readily apparent with reference to the following detailed description.

### DETAILED DESCRIPTION OF THE PREFERRED EMBODIMENTS

According to the present invention, the above objects and advantages are achieved by combining desired levels of N—P—K fertilizer components, a binder component, and one or more lubricating agents. In particular, a lubricant may be needed as a mold release agent to facilitate release of manufactured tablets from the manufacturing molds. Other inerts for anti-sticking, slow disintegration and binding of the composition in a tablet form are provided

In a preferred embodiment, the N—P—K fertilizer components include Ammonium Sulfate, Potash, and Triple Super Phosphate. Ammonium Sulfate provides the Nitrogen and is present in an amount of between 27% and 30% by weight of the composition. Potash provides the Potassium component and is present in the amount of between 27% and 30% by weight of the composition. Triple Super Phosphate provides the Phosphorus component and is present in an amount of between 19% and 22% by weight of the composition.

The binder component of the composition is Polyvinyl Pyrillidone K30 and is present in an amount of between 2% and 4% by weight of the composition.

Microcrystalline Cellulose is used in the composition as a disintegrant and is present in an amount of between 10% and 13% by weight of the composition. Microcrystalline Cellulose works in conjunction with the binder, Polyvinyl Pyrillidone K30, to control the rate of disintegration of the tablet in the chemical delivery system.

Hydrogenated vegetable oil is provided as a lubricant and is present in the amount of 2% and 4% by weight of the composition. Graphite powder may also be provided as a lubricant and is present in an amount of less than 1% by weight of the composition.

A surfactant may be desirable for even distribution of the components in the composition. In a preferred embodiment, the surfactant is Lathanol LAL powder in an amount of between 0.01% and 1.0% by weight of the composition. Calcium Silicate may further be added as a flow aid, to promote flow of the disbursed composition through the pipes of an irrigation system. Calcium Silicate, when used, is present in an amount of less than 1% by weight of the composition.

The following example is presented in order to provide a fuller understanding of the composition of the present invention and the manner of preparation, and is, therefore, not intended to limit the scope of the invention.

### EXAMPLE 1

| Component | Percent | Function | Range |
|---|---|---|---|
| Ammonium Sulfate (milled) | 28.6 | Active | 27-30 |
| Potash (milled) | 28.6 | Active | 27-30 |
| Triple Super Phosphate (milled) | 20.5 | Active | 19-22 |
| Microcrystalline Cellulose | 11.4 | Disintegrant | 10-13 |
| Polyvinyl Pyrillidone K30 | 2.9 | Binder | 2-4 |
| Water | 4.5 | Binder | 3-5 |
| Hydrogenated Vegetable Oil | 2.7 | Lubricant | 2-4 |
| Calcium Silicate | 0.5 | Flow Aid | <1 |
| Graphite Powder | 0.2 | Lubricant | <1 |
| Lathanol LAL Powder | 0.1 | Surfactant | <1 |
| TOTAL | 100.0% | | |

The composition of the above example is prepared according to the following procedure. The size of each batch is assumed to be twelve pounds.

To begin preparation of the 12-pound batch, the three fertilizer components (Ammonium Sulfate, Potash, and Triple Super Phosphate) are milled separately to a fine powder. It is preferred to use a Fitzpatrick model D6 Fitzmill, using swinging hammers, impact forward, fast speed, and a 0109 screen. Care must be taken to keep the temperature of the components from becoming too hot during the milling process so that activity of the components isn't compromised. Once the three fertilizer components are milled, blending of the fertilizer components should not be delayed. The milled fertilizer components are combined with the binder (i.e. Polyvinyl Pyrillidone K30) and dilutants, and blended until thoroughly mixed. It is preferred to use a Patterson Kelly V blender with liquid/solid bar. For a 12-pound batch, the elements should be mixed for approximately 1-2 minutes. Larger batch sizes will require a longer time (up to 10 minutes) to completely blend. Next, the water is added slowly through the bar while blending for forty seconds. Next, tumble blend the combined elements for one minute and allow to rest in blender overnight. Next, bar blend for forty seconds and then add the remaining ingredients and tumble blend for two minutes. Discharge the mixture from the blender and store in one or more tightly closed containers until ready for use in the tablet manufacturing process.

To manufacture the tablets, using the above manufactured composition, the following procedure is followed:

Set up a Stokes Model R Press with the desired size FFBE (flat face bevel edge tooling). Compress 100 gram tablets to hardness of 100-120 pounds, as measured with a Rimac Spring Tester with 1-½″ frame. The manufactured tablet height measures 0.5-1.5″. Store tablets in a tightly closed container for a minimum of one week before using. This “cure” time allows hardening to occur, thereby providing for more consistent and true results. In a preferred embodiment, the tablet has an outside diameter ranging between 2″ and 3″. In one embodiment, the outside diameter of the tablet measures 2.625″. The weight of each tablet ranges between 80 and 120 grams, depending upon the size. In one preferred embodiment, the tablet weight is 100 grams.

The manufactured tablets, comprised of the composition of the present invention, are primarily intended for use in a chemical delivery system of the type including a main water delivery line for directing a pressurized flow of water from a water source to one or more water discharge devices, as commonly found in an irrigation system (e.g. a sprinkler system). An airtight chamber is filled with a predetermined amount of the dry, water dispersible tablets. A water input line connects from a first location through a main water delivery line to the chamber containing the tablets, and a water output line connects from the chamber to a second location along the main water delivery line. The pressure of water flowing through the main water delivery line is higher at the first location than at the second location, causing a portion of the water flow to be diverted through the input line, into the chamber, through the output line, and feeding back into the main water delivery line at the second location. As water flows through the chamber, the dry water dispersible tablets, containing the composition of the present invention, gradually disintegrates causing a slow, controlled release of the N—P—K fertilizer into the water flowing through the main water delivery line. This mixture is then directed to one or more discharge devices (i.e. sprinkler heads, spray nozzles, remote sprinklers, and the like) for application onto plant life, including lawns, plants and botanicals.

While the instant invention has been described in accordance with various preferred embodiments thereof, it is recognized that departures from the instant disclosure are contemplated within the spirit and scope of the present invention which, therefore, should not be limited except as defined in the following claims under the doctrine of equivalents.

Now that the invention has been described

What is claimed is:

1. A fertilizer composition comprising:
a Nitrogen-containing component in an amount of between 27% and 30% by weight of the composition;
a Potassium-containing component in an amount of between 27% and 30% by weight of the composition;
a Phosphorus-containing component in an amount of between 19% and 22% by weight of the composition;
Polyvinyl Pyrillidone K30, as a binder, in an amount of between 2% and 4% by weight of the composition; and
Microcrystalline Cellulose, as a disintegrant, in an amount of between 10% and 13% by weight of the composition.

2. The fertilizer composition as recited in claim 1 wherein said Nitrogen-containing component is Ammondium Sulfate.

3. The fertilizer composition as recited in claim 1 wherein the Potassium-containing component is Potash.

4. The fertilizer composition as recited in claim 1 wherein the Phosphorus-containing component is Triple Super Phosphate.

5. The fertilizer composition as recited in claim 1 further comprising:
Hydrogenated Vegetable Oil, as a lubricant, in an amount of between 2% and 4% by weight of the composition.

6. The fertilizer composition as recited in claim 5 further comprising:
Calcium Silicate, as a flow aid, in an amount of less than 1% by weight of the composition.

7. The fertilizer composition as recited in claim 6 further comprising:
Lathannnol LAL Powder, as a surfactant, in an amount of less than 1% by weight of the composition.

8. The fertilizer composition as recited in claim 7 further comprising:
Graphite powder, as a lubricant, in an amount of less than 1% by weight of the composition.

9. A fertilizer composition comprising:
a Nitrogen-containing component in an amount of between 27% and 30% by weight of the composition;
a Potassium-containing component in an amount of between 27% and 30% by weight of the composition;
a Phosphorus-containing component in an amount of between 19% and 22% by weight of the composition;
a binder in an amount of between 2% and 4% by weight of the composition; and
a disintegrant in an amount of between 10% and 13% by weight of the composition.

10. The fertilizer composition as recited in claim 9 wherein said Nitrogen-containing component is Ammondium Sulfate.

11. The fertilizer composition as recited in claim 9 wherein the Potassium-containing component is Potash.

12. The fertilizer composition as recited in claim 9 wherein the Phosphorus-containing component is Triple Super Phosphate.

13. The fertilizer composition as recited in claim 9 further comprising:
Hydrogenated Vegetable Oil, as a lubricant, in an amount of between 2% and 4% by weight of the composition.

14. The fertilizer composition as recited in claim 13 further comprising:
Calcium Silicate, as a flow aid, in an amount of less than 1% by weight of the composition.

15. The fertilizer composition as recited in claim 14 further comprising:
Lathannnol LAL Powder, as a surfactant, in an amount of less than 1% by weight of the composition.

16. The fertilizer composition as recited in claim 15 further comprising:
Graphite powder, as a lubricant, in an amount of less than 1% by weight of the composition.
